(19) United States
(12) Patent Application Publication
(10) Pub. No.: US 2016/0158817 A1
(43) Pub. Date: Jun. 9, 2016

(54) HIGH POWER LASER SYSTEMS AND METHODS FOR MERCURY, HEAVY METAL AND HAZARDOUS MATERIAL REMOVAL

(71) Applicants: Mark S. Zediker, Castle Rock, CO (US); Brian O. Faircloth, Evergreen, CO (US); Daryl L. Grubb, Houston, TX (US); Paul D. Deutch, Houston, TX (US)

(72) Inventors: Mark S. Zediker, Castle Rock, CO (US); Brian O. Faircloth, Evergreen, CO (US); Daryl L. Grubb, Houston, TX (US); Paul D. Deutch, Houston, TX (US)

(73) Assignee: FORO ENERGY, INC., Littleton, CO (US)

(21) Appl. No.: 14/214,404

(22) Filed: Mar. 14, 2014

Related U.S. Application Data
(60) Provisional application No. 61/798,761, filed on Mar. 15, 2013.

(51) Int. Cl. B08B 9/08; B08B 7/00; C23G 5/00

(52) U.S. Cl. CPC B08B 9/0865; C23G 5/00; B08B 7/0042

(57) ABSTRACT

There are provides systems, methods and tools for delivering high power laser beams to selectively vaporizing contaminates in the surface layers of materials, and to remove these contaminates with minimal effect on the underlying substrate material. In particular, mercury contaminates can be removed in this manner.

This application claims, under 35 U.S.C. §119(e)(1), the benefit of the filing date of Mar. 15, 2013, of provisional application Ser. No. 61/798,761, the entire disclosures of each of which are incorporated herein by reference.

### BACKGROUND OF THE INVENTION

### Field of the Invention

The present inventions relate to methods, apparatus and systems for the delivery and use of high power laser beams in remote, hazardous, optically occluded and difficult to access locations, such as: oil fields, pipelines, underground mines, natural gas fields, hazardous waste locations, contaminated sites and structures, hulls of ships, tanks, holding facilities, chemical and manufacturing facilities, and nuclear reactors. The high power laser beams may be used at the delivered location for activities, such as, monitoring, vaporizing, heating, cleaning, surface treating and cutting.

As used herein, unless specified otherwise “high power laser energy” means a laser beam having at least about 1 kW (kilowatt) of power. As used herein, unless specified otherwise “great distances” means at least about 500 m (meter). As used herein, unless specified otherwise, the term “substantial loss of power,” “substantial power loss” and similar such phrases, mean a loss of power of more than about 3.0 dB/km (decibel/kilometer) for a selected wavelength. As used herein the term “substantial power transmission” means at least about 50% transmittance.

### SUMMARY

There is a continued need for a system that can deliver high power directed energy over great distances to small, difficult to access locations, positions or environments for use in activities such as analyzing, handling, neutralizing, vaporizing and removing, and cleaning up of hazardous waste, byproducts, unwanted substances and contaminated locations. There is also a need to analyze the contaminates on, within, or associated with the surfaces or materials. The present inventions, among other things, solve these and other needs by providing the articles of manufacture, devices and processes taught herein.

Accordingly, there is provided a method of removing mercury from a contaminated structure, including: directing a high power laser beam at a surface of the structure having mercury contamination; vaporizing the mercury; and, collecting and removing the mercury vapor.

Further the methods and systems may also have one or more of the following features: wherein the contaminated structure is an oil tanker ship; wherein the surface is an inner surface that was in contact with crude oil; wherein the temperature of the surface is controlled to maintain the integrity of the structure and to effect the rate of removal of the contaminate material; wherein the effect on the rate of removal is to maximize it; wherein the material that is vaporized is analyzed with a spectrometer during ablation, wherein the ablated material is identified; wherein the material that is vaporized is delivered to a mass spectrometer for analysis to determine the material being ablated; wherein the laser beam raises the temperature of the material to at least about 1,000 degrees C.; wherein the laser beam raises the temperature of the material to at least about 1,200 degrees C.; wherein the temperature of the surface is less than about 1,200 degrees C.; and creating a area of reduced pressure around an area where the laser beam is directed at the surface.

Still further there is provided a method of removing mercury from a contaminated structure, including: directing a high power laser beam at a surface of the structure having mercury contamination; vaporizing the mercury; and, collecting and removing the mercury vapor.

Moreover, there is provided a method of liberating a waste material from a substrate, without material changing the structural properties of the substrate, including: directing a high power laser beam having at least about 5 kW of power at a substrate, the substrate having determinable physical properties defining the structural strength of the substrate; the substrate comprising a base material and a waste material; and, wherein the high power laser beam is directed in a beam delivery pattern, whereby the substrate is heated vaporizing the waste material while not materially weakening the structural strength of the substrate.

Additionally, the methods and systems may also have one or more of the following features: wherein the base material is a metal; wherein the base material is a metal comprising iron; wherein the base material is steel; wherein the steel is stainless steel; wherein the steel is carbon steel; wherein the substrate comprises a hold of a ship; wherein the substrate comprises a tubular; wherein the waste material is a heavy metal; wherein the waste material is NORM (naturally occurring radio active materials); and wherein the waste material is mercury.

Furthermore, there is provided a method of liberating a waste material from a substrate, without material changing the structural properties of the substrate, including: directing a high power laser beam having at least about 5 kW of power at a substrate, the substrate having determinable physical properties defining the structural strength of the substrate; the substrate comprising a base material and a waste material; and, wherein the high power laser beam is directed in a beam delivery pattern to provide an energy absorption per unit length, whereby the energy absorption per unit length is at a level to vaporize the waste material while not materially weakening the structural strength of the substrate.

Further the methods and systems may also have one or more of the following features: wherein the energy absorption per unit length is from from about 100 Joules/cm² to about 1,000 Joules/cm², of from about 200 Joules/cm² to about 400 Joules/cm² and more preferably in the range of from about 600 Joules/cm² to about 1000 Joules/cm²; and wherein the waste material comprises mercury, the base material comprises steel, and the energy absorption per unit length is from from about 100 Joules/cm² to about 1,000 Joules/cm², of from about 200 Joules/cm² to about 400 Joules/cm² and more preferably in the range of from about 600 Joules/cm² to about 1000 Joules/cm².

Yet still further there is provided a system for removing mercury contamination from a structure, the system having: a high power laser for providing a laser beam having at least about 5 kW of power; a high power laser umbilical comprising a high power optical fiber having a proximal and a distal end; the proximal end of the optical fiber in optical communication with the high power laser, whereby the laser beam is capable of being transmitted through the optical fiber to the distal end; a vehicle, the vehicle comprising a means for changing the location of the vehicle, a positioning system, an arm having a proximal and a distal end, and a laser head; the laser head having an optics package, a laser delivery port, and a waste material inlet port; the distal end of the optical fiber in optical communication with the optics package, whereby the laser beam is capable of being transmitted from the high power laser to the optics package; the optics package positioned in the laser head, whereby the laser beam is capable of being delivered through the laser port; the waste material inlet port in fluid communication with a waste removal system; and, the laser head attached to the distal end of the arm, the arm mechanically associated with the positioning system.

Further the methods and systems may also have one or more of the following features: wherein the positioning system is a two axis positioning system; wherein the positioning system is a three axis positioning system; whereby the system is capable of autonomous operation; wherein the waste material removal system comprises a pump and a waste removal umbilical; and, having a means to create a reduced pressure zone.

### BRIEF DESCRIPTION OF THE DRAWINGS

FIG. 1 is a perspective view of an embodiment of a laser robotic system in accordance with the present inventions.

FIG. 2 is a perspective view of an embodiment of a laser robotic processing system in accordance with the present inventions.

FIG. 3 is a perspective view of an embodiment of an autonomous laser robotic processing system in accordance with the present inventions.

### DESCRIPTION OF THE PREFERRED EMBODIMENTS

In general, the present inventions relate to systems, methods and tools for applying laser beams and laser energy for removing, mitigating, cleaning and ablating waste, unwanted substances, and coatings layers of materials, from surfaces, structures and sites. In particular the present inventions relate to systems, methods and tools for the delivery of predetermined laser energy to surfaces, structures and sites that contain hazardous, or otherwise undesirable, unwanted or unneeded, waste or substances for the mitigation, removal, and containment of these wastes or substances.

Many large structures, such as tanks, storage facilities, hulls and inner compartments of ships, ships, buildings, factories and other objects and structures have been or will be contaminated by hazardous, dangerous and other types of undesirable materials and substances. High power lasers can be used to ablate, vaporize, loosen, remove, or otherwise mitigate these materials so that they may be safely collected, analyzed, removed, disposed of, and combinations and variations of these. Examples of such undesirable materials or substances are mercury and NORM (naturally occurring radio active materials).

Generally, the decommissioning of vessels, pipelines and bulk storage structures, e.g., tanks, may often be hampered by the presence of mercury impacted in the coatings of the surface, the surface itself or trapped within layers of corrosion byproducts. Under present regulations the mercury concentration must be below 10 ppm before the substrate material can be shipped for reprocessing. This limit may be lowered, increased, or changed by subsequent regulations, rule or practices, and may be different for different countries and locations throughout the world. Thus, levels of residual mercury after laser treatment of from about 20 ppm to about 5 ppm, lower than about 30 ppm, lower than about 20 ppm, lower than about 10 ppm, lower than about 5 ppm, and lower than about 1 ppm are contemplated by the present inventions. The 10 ppm concentration can be translated to a residual mercury concentration on the surface of the subject substrate, if the volume of the substrate is known. Ideally, the mercury concentration should be reduced to a sufficiently low level that regardless of the volume, the melt (when the substrate is melted, e.g., during scrap reprocessing or recycling) will not exceed the 10 ppm limitation. Consequently, the preferred solution would leave essentially no, or most preferably no detectable mercury on the surface, when, e.g., using an X-ray fluorescence (XRF) system, when the surface is scratched and a mercury vapor monitor cannot detect any liberated mercury, or other similar commonly used methods of testing for or detecting the presence of mercury in environmental settings.

A laser can be used to effectively liberate mercury contamination from an epoxy coated steel surface and a stainless steel surface. The process parameters cover a wide range, making it feasible to remove mercury with, for example, a robotic based embodiment, a handheld based embodiment and combinations and variations of these and others. A robotic based system, for example, may be suitable for remediating large flat areas. A hand held system, for example, may be used on non-flat areas, or areas that were difficult to get a larger system into. Although it should be understood that either system may be used in various applications and settings, as well as, other types of laser processing systems may be utilized.

For robotic embodiments, it is preferred to use a robotic vehicle that may have, for example, an articulated arm assembly that provides for full 360 degree movement of the end of the arm, a laser delivery head on the end of the arm, and a waste collection and removal assembly associated with the laser head, so that as the laser beam alters the hazardous material it can be collected and removed. Further, the system may have imaging and monitoring systems, and may have image recognition systems that in part, or completely controls the movement of the robot and placement of the laser beam and beam pattern. Many different types of hardware and systems may be used in the present inventions, for example: magnetic track may be affixed to vertical and over head substrates and the laser system engaged and locked into the track and then moved along the track; wheeled; and tracked (e.g., caterpillar), walking, magnetic and other types of carriages, vehicles or sources of movement.

Examples of other types of carriages, vehicles and sources of movement are disclosed and taught in U.S. patent application Ser. No. 14/213,212, the entire disclosure of which is incorporated herein by reference.

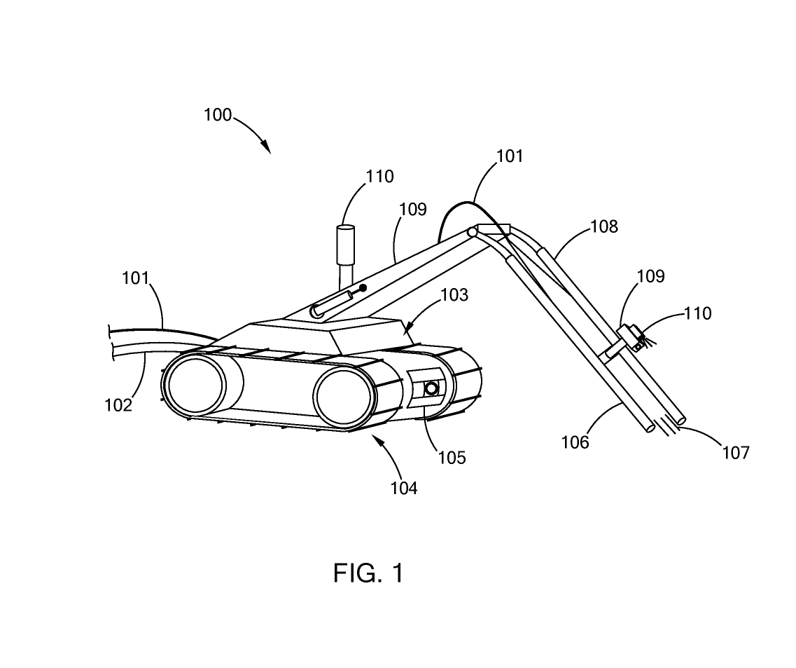

Turning to FIG. 1 there is a perspective view of an embodiment of a laser robotic treatment system 100. The system 100 has a tracked based vehicle 105 that has an x, y, z, positioning assembly 103, that includes a movable and articulated arm assembly 109, that can position the laser head and vacuum assembly, and move the laser beam in a predetermined beam delivery pattern and a predetermined delivery rate. Thus, the positioning assembly 103 can move and position the laser beam 107, and the vacuum waste removal tubes 108. The system 100 can deliver a laser beam to laser treat a large area of a substrate, e.g., interior of a ship, at predetermined rates and patterns.

The system 100 has a light source 110 and a camera 109 mounted near the end of the arm assembly 109. This camera 109 provides a view of the laser processing operation and the substrate as it is being processed. The system 100 has a second monitor 110 assembly, that may be a 3-D viewing system with illumination source, or other types of visual monitoring system. Further, IR viewing systems may be used with the system 100.

The high power laser beam 107 is provided by an umbilical 101 that has a high power optical fiber. Data and control information may also be transmitted through lines associated with the umbilical, wirelessly (depending upon the environment of use), or the system may be programed to operation autonomously. The contaminated vapors from the laser treatment of the substrate are removed from the treatment area by line 102. These contaminated vapors are then further processed and appropriately handled and disposed of.

It should be noted that two axis, three axis or more, including six axis positioning systems can be utilized with the laser tool to deliver the laser beam pattern to a substrate.

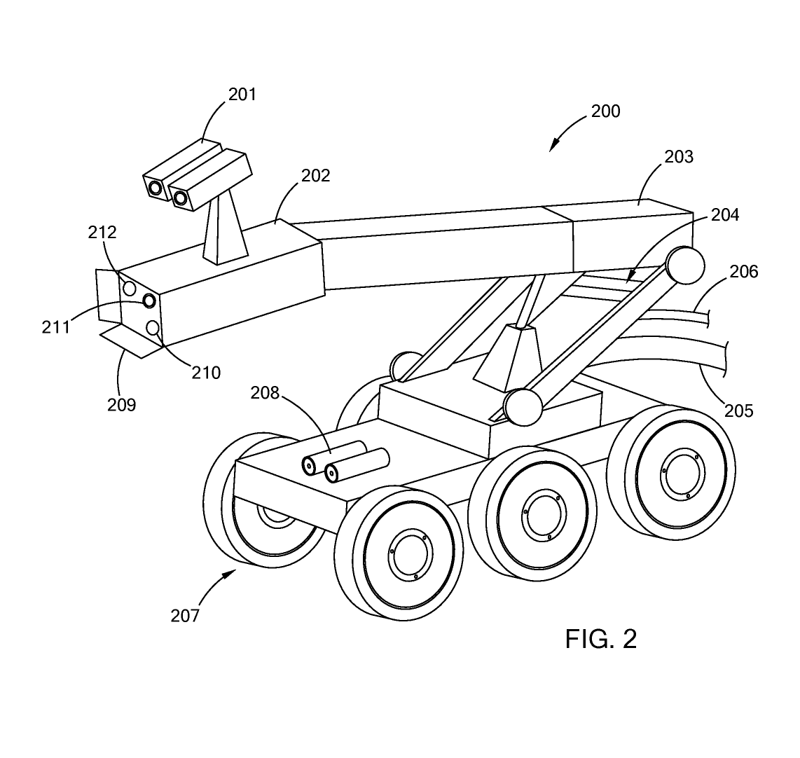

Turning to FIG. 2, there is provided a perspective view of an embodiment of a laser robotic processing system. The system 200 has a robotic vehicle having an x,y,z positioning assembly 204. The system 200 has a laser fiber umbilical 206 and a waste vapor removal umbilical 205. It should be noted that these two umbilicals can be combined into a single multi-component umbilical, and additional lines or umbilicals may also be used for power, video, data, communications, etc. The positioning assembly 204 also includes an expandable and articulated arm 203.

At the distal end of the arm 203, there is a laser head 202. The laser head 202 contains an optics assembly for shaping and directing the laser beam, it may also contain beam steering means such as scanners. The laser head 202 has two inlet openings 210, 212, for withdrawing the vaporized waste material, and a laser delivery port 211 from which the laser beam is propagated. It should be understood that one or more laser ports for the delivery of one or more laser beams and one, two, three or more inlet openings can be present. A 3-D monitoring assembly 201 can be associated with the laser head 202.

A shielding assembly, 209, is employed. The embodiment of this shielding assembly 209, as shown in FIG. 2, would have four panels, only two of which are shown in the figure. The other two panels would be placed on the other two reciprocal edges of the laser head 202. In general, and preferably, the shielding assembly provides the ability to substantially seal against the substrate, to create a partial or essentially complete low pressure, or reduced pressure zone or area, to ensure that all of the waste vapors and materials from the laser operation are drawing into the waste material openings 212, 210 and removed via the waste umbilical. The shielding assembly may also prevent chips or larger pieces of materials from escaping the inlet opening. The shielding assembly can also provide shielding to the laser, making the system a Class III system, more preferably a Class II system, and still more preferably a Class I system, under the requirements performance criteria of 21 C.F.R. §1040.10 (Revised as of Apr. 1, 2012), the entire disclosure of which is incorporated herein by reference, additionally example of shield assemblies, and shielding are provided in U.S. patent application Ser. No. 14/139,680 and in Ser. No. 14/213,212, the entire disclosure of each of which is incorporated by reference.

The hood, the inlet ports and both, may be any configuration and preferably are configured to coincide with the shape of the laser beam spot or the laser beam pattern. Thus for example, if the laser beam is a line, or an elliptical pattern, the hood may be elongated, to follow the shape of the laser beam spot, e.g., a line, an ellipse, and may have rectangular vacuum ports.

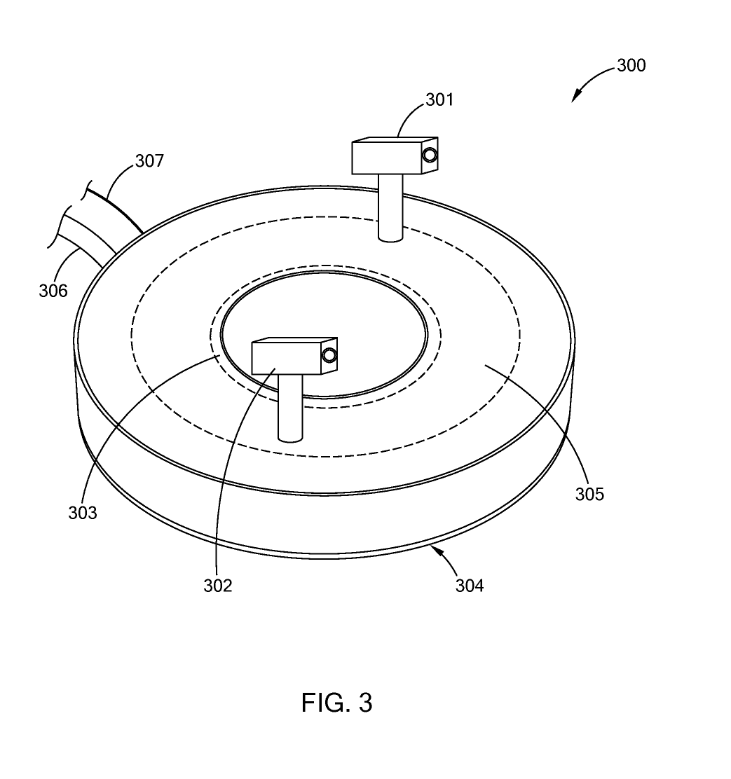

Turning to FIG. 3 there is shown a perspective and partially transparent view of an autonomous laser delivery system. The system 300 has a laser umbilical 307 and a waste removal umbilical 306. The system 300 has a circular robotic platform. The system 300 has a automatic control system that may have controllers, processors, memory, a program, or other control related hard ware and software so that the automatic control system can operate the robot without the need for control signals, commands or human interaction from a source outside of the robot. The autonomous robot system is programed to move in a particular pattern and a particular rate over, or on, a substrate material. The laser head 303 is inward, closer to the center. The system 300 and has a annular waste removal port 304 that is outward, e.g., surrounds the laser head 303, and removes the vapors and any other waste liberated by the laser beam. Monitors, e.g., video cameras, 301, 302 can be used to provide real time video images of the operation and the system 300. Preferably the field of view for each camera is adjustable, and with both cameras, the entirety of the system and the nearby area of the substrate can be viewed.

It should understood that, among other variations in the systems and processes: more than one laser head, may be used on a single system; one or more monitoring systems may be used and would include, for example, visual wavelength video cameras, laser range finding, IR video cameras, radar, and sonic based systems; waste material, e.g., mercury, monitoring equipment may be included in the system to ensure that the waste material has been sufficiently removed from the substrate (e.g., a high power laser can be used to ablate the surface and a mass spectrometer can then be used to analyze the vaporized particles (e.g. Laser Induced Breakdown Spectroscopy (LIBS)); in those cases where the system has on-board monitoring equipment, the laser power, beam pattern, or other laser delivery related parameters can be adjusted by an operator based upon the monitoring data, or the system could be programed to automatically make such adjustments; one, two, three or more systems may be simultaneously operated on a substrate; when using multiple systems they may each have a different laser beam power, duration of heat, or laser beam pattern, and can be operated serially, with one following the other in performing the laser operation on the substrate; the multiple systems may all have the same laser beam delivery parameters; the system may be moved by a driven vehicle, such as a tractor; multiple and varied umbilical lines and combinations may be used; multiple and varied shapes of the waste ports or openings may be used; and combinations and variations of these.

By way of example, older oil tankers, tanks, and pipe lines may be contaminated with mercury. This mercury contamination makes it very difficult, and costly to decommission these structures. Their clean up using conventional mechanical and solvent techniques is time consuming and dangerous, to name a few problems with it.

A laser robot with a vacuum system can be used to remotely clean the interior of such structures, removing sufficient amounts, and preferably all, of the mercury (or other waste material) to permit the structures to be safely decommissioned, e.g., sectioned up and used for strap or otherwise disposed of.

The high power laser beam can be scanned or otherwise directed across a contaminated interior surface, e.g., the inner surface of a hull or hold of a ship, to locally raise the temperature of the surface to vaporize the mercury preferably, without altering the strength of the structure. The mercury vapors can then be removed by the associated vacuum system that is located near the laser beam delivery point.

Preferably the lines or conduits for waste removal will be separate from the umbilicals used for control data information, image transmission, and providing the high power laser beam, among other things. Although, these may be combined into a single multi-channel conductor.

For more limited volumes, the collection and disposal can be part of the vehicle, and more preferably for autonomous vehicles, eliminating the need to continuous flow the Hg (or other waste) vapors away from the location or area where the laser operation is being performed. The Hg vapors can be held, e.g., absorbed by a material designed to capture or otherwise hold Hg waste materials. This Hg holding material may be for example Mersorb® and can disposed of after the laser treatment process is complete.

In an embodiment a high power laser (>1 kW) can be used to instantaneously raise the surface temperature of a substrate material to a predetermined temperature. Typically this temperature rise can be instantaneous, or essentially instantaneous, e.g., less than about 0.1 seconds, less than about 0.001 and less than about 0.0001 seconds; although the beam properties may be such that if longer times are desirable they may be utilized. Additionally, the laser beam properties and delivery parameters may be such as to provide for varying heating steps, e.g., preheating step, post heat, incremental, etc. The mercury may, for example, exist as elemental mercury impacted into the coatings or surfaces, or it may be a compound of mercury resulting from the interaction of sulfur or other trace elements that readily combine with mercury. The preferred goal is to remove, and more preferably completely remove, the mercury and all of its potential compounds before further work is performed on the substrate during the decommissioning process. This can be accomplished by, for example, raising the temperature of the surface to just below the melting temperature of the substrate material, e.g., 1400° C. (for steel). Thus, depending upon the substrate surface its temperature may be raised up to at least about 500° C., at least about 1000° C., at least about 1200° C., at least about 1400° C., at least about 1600° C. and greater. The temperature of the substrate, as well as the depth of the contamination and potentially other factors, should be factored into the determination of the amount of time that the substrate will need to be kept at the elevated temperature.

The absorbed energy per unit length can be a preferred parameter to monitor and characterize the laser process in removing or otherwise mitigating a waste material, such as Hg. The absorbed energy per unit length, i.e., the absorbed energy level, is typically directly related to the removal rate of Hg. The heating of the substrate is directly proportional to the energy absorbed, rather than the fluence of the laser beam. In this manner generally, the higher the energy absorbed per unit length, the higher the surface temperature of the substrate, and as such, more efficient removal of Hg. Energy absorption per length can generally be explained by the following formula:

dQ=ρ*Cp*dT

Where dQ is heat energy absorbed (or deposited), ρ is density, Cp is heat capacity and dT is rise in temperature (change). The heat of vaporization is not important in this analysis, because the surface is being raised to temperature well in excess of the boiling point of mercury to force it to desorb rapidly. In addition, the mercury naturally desorbs over time even at room temperature. However to achieve rapid desorption, it is necessary to elevate the temperature of the surface containing the mercury. For example, 1 Joule of energy will increase the surface temperature by 20 C for a 1 cm×1 mm beam cross section. This small temperature increase will accelerate the desorption process, but only modestly. To achieve a rapid desorption (<1 sec), it is necessary to raise the surface temperature to as high as possible. For example, if the surface temperature is raised to 1000 C, then the desorption occurs rapidly <0.1 sec but requires only 60 Joules of energy. The present high power laser systems are capable of greatly exceeding this energy deposition rate enabling the rapid desorption of mercury.

Thus, for the removal of Hg entrapped in, associated with, or otherwise contained in a metal substrate the absorbed energy per unit area should be at least about 10 Joules/cm², at least about 100 Joules/cm² and at least about 1000 Joule/cm², and preferably in the range of from about 100 Joules/cm² to about 1,000 Joules/cm², of from about 200 Joules/cm² to about 400 Joules/cm², and more preferably in the range of from about 600 Joules/cm² to about 1000 Joules/cm².

### EXAMPLES

The following examples are provided to illustrate various embodiments of laser systems and processes of the present inventions. These examples are for illustrative purposes, and should not be viewed as, and do not otherwise limit the scope of the present inventions.

### Example 1

Elemental mercury is rapidly removed by bringing the substrate's surface temperature above the boiling point of mercury (356° C.). The mercury which is trapped in cracks, crevices, and pores in the surface readily vaporizes when the temperature exceeds the boiling point. As the temperature is increased even further, the vapor pressure will also increase, driving the mercury from the substrate at an ever increasing rate. The melting point of most steels is on the order of 1450° C. and stainless steel is on the order of 1510° C., which is the maximum surface temperature that can be applied without causing damage to the substrate. As the surface temperature is increased beyond the boiling point of mercury, the vaporization rate of the mercury will increase linearly with temperature and the time to drive the mercury from the surface will decrease rapidly with increasing temperature. The result is that the mercury can be driven from the surface at a much greater rate than if the part is held at a temperature below or equal to the boiling point of mercury.

### Example 2

Mercury Sulfide or cinnabar is a natural state for mercury and may be brought in, with the material being stored or transported. It may also form if elemental mercury is present along with reducing compounds such as hydrogen sulfide. The cinnabar will begin to decompose into elemental mercury and sulfur dioxide when the substrate is heated above 200° C. If the surface temperature is at or below the boiling point of mercury, then some of the mercury will remain on the surface even after a long processing temperature because it is a diffusion process that depends on the equilibrium vapor pressure with the surrounding environment for the removal of the mercury. If the heating process is not performed in a partial vacuum, then the mercury will remain on the surface even after processing. The removal rate can be enhanced by a partial vacuum, which rapidly removes the mercury as it diffuses from the surface. This is a relatively slow process dictated by the partial pressure of mercury above the substrate at a given temperature. A faster process occurs above the boiling point of mercury, where the cinnabar is rapidly reduced and the mercury is rapidly vaporized from the surface. The laser process can be tuned to provide an ideal temperature/exposure profile for a substrate's surface driving nearly all the mercury or mercury sulfide from the surface.

### Example 3

Many of the surfaces used in the transport or storage of petroleum products are coated with a protective epoxy coating to prevent corrosion of the underlying steel. These coatings can become impacted with mercury or compounds of mercury and must be removed. The laser can rapidly heat the coating and remove it by either burning it, or causing a thermal fatigue at the coating substrate interface. A continuous wave laser will burn the coating off, while a pulsed laser will fracture the coating into small particles without burning. Further, in low thermal conductivity materials, such as, e.g., epoxy, the material can be vaporized with a short adiabatic laser pulse while leaving the base material untouched. The laser system can be set up to concurrently remove the coating, evaporate mercury and reduce any compounds of mercury embedded in the coatings or surface of the substrate.

Examples 4

Corrosion can easily be removed from a surface with a laser since there is a weak bond between the corrosion layers and the substrate. As the corrosion layers heat up, a large thermal gradient develops across that bond, which causes significant mechanical stresses and leads to the rapid failure of that bond. As the bond fails, the corrosion layer will “pop” off of the surface and it can be readily removed by a vacuum system. Any mercury contained embedded in the corrosion layers is removed with the expelled corrosion products.

### Example 5

The test cell setup for characterizing the removal of mercury from two different samples consisted of a laser, a robot, a beam delivery system and a vacuum system. The laser is an IPG 20 kW fiber laser, capable of being operated from very low powers to 20 kW. The output of the laser can be continuous, or it can be pulsed at a preprogrammed pulse width and duty cycle. The tests for this example were conducted with the laser operating in the continuous mode. The robot is a 6 axis Motoman YASNAAC XRC Series robot that can be easily programmed to deliver the laser beam over a pre-programmed path, at a pre-programmed rate.

At high translation rates, (>50 in/min) the robot acceleration has to be taken into account in either the results, or by programming an acceleration path into the program. For these tests, the sample was small that a pre-acceleration path was not programmed into the test run. The laser beam delivery system consisted of a commercially available collimator assembly from IPG and a Laser Mech beam tube and lens holder for holding a custom output optic. The beam was transformed from a 1.5″ diameter to a 2″ wide thin line on the surface of the part. This beam configuration is a preferable means of rapidly heating an area of a part by simply sweeping the line in a direction perpendicular to the broad dimension. The laser passes over the sample producing ash from the coating that has been ablated and charred by the laser beam.

The ash and mercury liberated from the surface is collected by a nozzle having the same width as the laser beam, with a flow of 110 cfm provided by the vacuum system. The vacuum system is a mercury vacuum system with a liquid mercury trap and an activated charcoal filter to absorb any mercury vapors that are not captured in the trap. The vacuum system was provided by Tiger-Vac MRV-1000 SS Series.

### Example 6

The test procedure consists of 11 steps: 1) Mark sample into regions to be tested, 2) Characterize mercury concentration using an XRF in each region, 3) Set sample on robot stage and affix mercury vapor monitor and exhaust system to same stage, 4) Program the robot to pass the laser beam over the region of interest at a predetermined speed, 5) Set up cameras to record the process, 6) Exit room and program the laser for the predetermined power, 7) Execute robot program which controls the robot and the laser, 8) Measure the surface temperature with an IR camera during the process and while the part cools, 9) Survey the region with an XRF in at least three different spots in the region, 10) Perform a scratch test with the mercury vapor monitor pickup in front of the region being scratched and determine if any residual mercury is liberated by the mechanical force, and 11) Record the data.

A test matrix was completed varying the power from 10 kW to 1 kW and varying the robot speed from 300 in/min to 40 in/min. Two samples tested, a ⅜″ thick on steel plate coated with an epoxy coating and a stainless steel gate valve that had no coatings other than the mercury contamination.

### Example 6a

A ⅜″ thick carbon steel plate coated with an epoxy coating and containing a mercury contamination was used as a sample for laser treatment. The sample was surveyed prior to the tests, and the survey results were cataloged according to the region of the sample. The test results are set forth in Table I.

TABLE I

| | | | | XRF | XRF | | Area | | |
|---|---|---|---|---|---|---|---|---|---|
| | | Laser | Linear | Pre-lase | Post-Lase | Processing | Processing | Blade | |
| Run | Region | Power | Speed | Survey | Survey | Rate | Rate | Scrape | |
| No. | Tested | (kW) | (in/min) | (ug/cm2) | (ug/cm2) | (sq. ft/hr) | (sq. m/hr) | (ppm) | Notes |
| 1 | A | 10 | 200 | 330 | non- | 167 | 19 | non- | Surface Melt |
| | | | | | detect | | | detect | |
| 2 | B | 10 | 400 | 370 | 16-17 | 333 | 37 | | Ash remained |
| | | | | | | | | | on surface |
| 3 | B | 10 | 300 | 16-17 | non- | 250 | 28 | | Some |
| | | | | | detect | | | | Surface Melt |
| 4 | C | 10 | 300 | 579 | non- | 250 | 28 | | Some |
| | | | | | detect | | | | Surface Melt |
| 5 | D | 4.9 | 300 | 542 | prewipe: | 250 | 28 | | no vacuum- |
| | | | | | 37 | | | | heavy ash |
| | | | | | post | | | | |
| | | | | | wipe: | | | | |
| | | | | | 25-33 | | | | |
| 6 | D | 4.9 | 300 | 25-33 | non- | 250 | 28 | 0.003 | Surface |
| | | | | | detect | | | | appeared |
| | | | | | | | | | clean |
| 7 | E | 4.9 | 300 | 421 | 17-23 | 250 | 28 | 0.005 | Ash remained |
| | | | | | | | | | on surface |
| 8 | F | 4.9 | 200 | 336 | non- | 167 | 19 | 0.003 | Ash remained |
| | | | | | detect | | | | on surface |
| 9 | G | 2.75 | 100 | 527 | 18-20 | 83 | 9 | | Ash remained |
| 10 | H | 2.75 | 40 | 434 | non- | 33 | 4 | | on surface |
| | | | | | detect | | | | Ash remained |
| | | | | | | | | | on surface |
| 11 | 1 | 1.2 | 10 | 424 | non- | 8 | 1 | | Ash remained |
| | | | | | detect | | | | on surface |
| 12 | J | 4.9 | 100 | 366 | 5 | 83 | 9 | | Ash remained |
| | | | | | | | | | on surface |

Run number 5 had an anomaly, where the vacuum system was not turned on during the laser processing. The mercury vapor monitor detected a significant amount of mercury exiting through the exhaust system. Mid-way through the testing, a blade was used to physically scrape the cleaned surface and the mercury vapor monitor was placed adjacent to the region being scraped. All non-detect surfaces that were tested produced a reading of 0.003 or less. Only the regions where the XRF indicated some residual mercury was present did the reading increase beyond the 0.003 level.

### Example 6b

A stainless steel gate valve having mercury contamination was used as a sample for laser treatment. The sample was surveyed prior to the tests, and the survey results were cataloged according to the region of the sample.

The sample was not flat, but had a deep depression in the center of the valve and ridges, which is where the valve would seal against its seat. The results of this laser treatment are show in Table II.

TABLE II

| | | | | XRF | XRF | | Area | | |
|---|---|---|---|---|---|---|---|---|---|
| | | Laser | Linear | Pre-lase | Post-Lase | Processing | Processing | Blade | |
| Run | Region | Power | Speed | Survey | Survey | Rate | Rate | Scrape | |
| Number | Tested | (kW) | (in/min) | (ug/cm2) | (ug/cm2) | (sq. ft/hr) | (sq. m/hr) | (ppm) | Notes |
| 13 | 1 | 5 | 100 | 110 | non- | 83 | 9 | 1.93 | Suface |
| | | | | | detect | | | | looked clean |
| 14 | 2 | 2.75 | 40 | 123 | non- | 33 | 4 | 0.031 | Surface |
| | | | | | detect | | | | discolored |
| 15 | 3 | 5 | 40 | 85 | non- | 33 | 4 | 0.003 | Some |
| | | | | | detect | | | | surface melt |

During the run, the surface of the valve appeared to reach a higher temperature than for the case of the steel sample and the heat dissipated substantially slower than it did for the steel sample. Generally, a longer “heating” duration should result in more of the mercury being driven off. However, slowing down the laser speed may cause surface melting. Thus, the laser power was reduced in half for Run 14. By decreasing the speed to 40″/min while decreasing the power to 2.75 W, the energy deposited (4 kJ/in) is actually higher than in run number 1 (5kJ/in). This resulted in the XRF indicating a non-detect, even in the depression region of the valve. However, the scratch test still showed a factor of 10x higher reading than obtained on the steel samples. Therefore, a higher temperature may be needed to drive the mercury out of the stainless steel than carbon steel. Run 15 was performed at an even higher energy deposition rate (7.5 kJ/in), which resulted in no residual mercury being released during the blade scrape test. However, there was some surface melting evident.

### Example 7

The substrate material can be a powder, debris or loose material. The laser beam is configured to provide sufficient energy to vaporize the Hg to a certain depth of the material, after which that depth (preferably slightly less, to make sure that no Hg is missed) of the material is removed. After removal of the laser remediated layer of the substrate material, the laser treating and subsequent removal operation are continued until the contaminated material is removed. Here unlike a solid, where the melting of a substrate is generally not preferred, the melting of the powder or loose waste material can be beneficial by in effect binding the material together, creating a hard outer shell, and combinations and variations of these.

The hazardous waste removal/mitigation tools, systems, applications and operations may find use in activities such as: off-shore activities; subsea activities; decommissioning structures such as, oil rigs, oil platforms, offshore platforms, factories, nuclear facilities, nuclear reactors, pipelines, bridges, etc.; cutting and removal of structures in refineries; civil engineering projects and construction and demolitions; concrete repair and removal; mining; well decommissioning; well workover; heat treating; workover and completion; flow assurance; and, combinations and variations of these and other activities and operations.

A single high power laser may be utilized as source of laser energy for the hazardous waste removal/mitigation tools and systems, laser converters, and/or the laser drilling heads and laser patterns, or there may be two or three high power lasers, or more for one deuterium oxide laser fluid jet having a multi-laser system, or there may be several deuterium oxide laser fluid jet each having its own primary laser, and combinations and various of these. High power solid-state lasers, specifically semiconductor lasers and fiber lasers are preferred, for the laser source, because of their short start up time and essentially instant-on capabilities. The high power lasers for example may be fiber lasers, disk lasers or semiconductor lasers having 5 kW, 10 kW, 20 kW, 50 kW, 80 kW or more power and, which emit laser beams with wavelengths in the range from about 455 nm (nanometers) to about 2100 nm, preferably in the range about 400 nm to about 1600 nm, about 400 nm to about 800 nm, 800 nm to about 1600 nm, about 1060 nm to 1080 nm, 1530 nm to 1600 nm, 1800 nm to 2100 nm, and more preferably about 1064 nm, about 1070-1080 nm, about 1360 nm, about 1455 nm, 1490 nm, or about 1550 nm, or about 1900 nm (wavelengths in the range of 1900 nm may be provided by Thulium lasers). An example of this general type of fiber laser is the IPG YLS-20000. The detailed properties of which are disclosed in US patent application Publication Number 2010/0044106. Thus, by way of example, there is contemplated the use of four, five, or six, 20 kW lasers to provide a laser beam having a power greater than about 60 kW, greater than about 70 kW, greater than about 80 kW, greater than about 90 kW and greater than about 100 kW. One laser may also be envisioned to provide these higher laser powers.

The various embodiments of the hazardous waste removal/mitigation tools, systems, applications and operations may be used with various high power laser systems, tools, devices, and conveyance structures and systems. For example, embodiments of the hazardous waste removal/mitigation tools and systems and operations may use, or be used in, or with, the systems, conveyance structures, lasers, tools and methods disclosed and taught in the following US patent applications and patent application publications: Publication No. 2010/0044106; Publication No. 2010/0215326; Publication No. 2012/0275159; Publication No. 2010/0044103; Publication No. 2012/0267168; Publication No. 2012/0020631; Publication No. 2013/0011102; Publication No. 2012/0217018; Publication No. 2012/0217015; Publication No. 2012/0255933; Publication No. 2012/0074110; Publication No. 2012/0068086; Publication No. 2012/0273470; Publication No. 2012/0067643; Publication No. 2012/0266803; Publication No. 2012/0217019; Publication No. 2012/0217017; Publication No. 2012/0217018; Ser. No. 13/768,149; Ser. No. 13/782,869; Ser. No. 13/222,931; Ser. No. 14/139,680; and Ser. No. 14/080,722, the entire disclosure of each of which are incorporated herein by reference.

The various embodiments of devices, systems, tools, activities and operations set forth in this specification may be used with various high power laser systems and umbilicals or conveyance structures, in addition to those embodiments of the Figures and in this specification. The various embodiments of devices systems, tools, activities and operations set forth in this specification may be used with: other high power laser systems that may be developed in the future: with existing non-high power laser systems, which may be modified, in-part, based on the teachings of this specification, to create a high power laser system; and with high power directed energy systems. Further, the various embodiments of devices systems, tools, activities and operations set forth in this specification may be used with each other in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular Figure.

The inventions may be embodied in other forms than those specifically disclosed herein without departing from their spirit or essential characteristics. The described embodiments are to be considered in all respects only as illustrative and not restrictive.

What is claimed:

1. A method of removing mercury from a contaminated structure, the method comprising:
a. directing a high power laser beam at a surface of the structure having mercury contamination;
b. vaporizing the mercury; and,
c. collecting and removing the mercury vapor.

2. The method of claim 1, wherein the contaminated structure is an oil tanker ship.

3. The method of claim 2, wherein the surface is an inner surface that was in contact with crude oil.

4. The method of claim 1, wherein the temperature of the surface is controlled to maintain the integrity of the structure and to effect the rate of removal of the contaminate material.

5. The method of claim 1, wherein the effect on the rate of removal is to maximize it.

6. The method of claim 1, wherein the material that is vaporized is analyzed with a spectrometer during ablation, wherein the ablated material is identified.

7. The method of claim 1, wherein the material that is vaporized is delivered to a mass spectrometer for analysis to determine the material being ablated.

8. The method of claim 1, wherein the laser beam raises the temperature of the material to at least about 1,000 degrees C.

9. The method of claim 1, wherein the laser beam raises the temperature of the material to at least about 1,200 degrees C.

10. The method of claim 4, wherein the temperature of the surface is less than about 1,200 degrees C.

11. The method of claim 1, comprising creating a area of reduced pressure around an area where the laser beam is directed at the surface.

12. A method of removing mercury from a contaminated structure, the method comprising:
a. directing a high power laser beam at a surface of the structure having mercury contamination;
b. vaporizing the mercury; and,
c. collecting and removing the mercury vapor.

13. A method of liberating a waste material from a substrate, without material changing the structural properties of the substrate, the method comprising:
a. directing a high power laser beam having at least about 5 kW of power at a substrate, the substrate having determinable physical properties defining the structural strength of the substrate;
b. the substrate comprising a base material and a waste material; and,
c. wherein the high power laser beam is directed in a beam delivery pattern, whereby the substrate is heated vaporizing the waste material while not materially weakening the structural strength of the substrate.

14. The method of claim 13, wherein the base material is a metal.

15. The method of claim 13, wherein the base material is a metal comprising iron.

16. The method of claim 13, wherein the base material is steel.

17. The method of claim 16, wherein the steel is stainless steel.

18. The method of claim 16, wherein the steel is carbon steel.

19. The method of claim 14, wherein the substrate comprises a hold of a ship.

20. The method of claim 14, wherein the substrate comprises a tubular.

21. The method of claim 14, wherein the waste material is a heavy metal.

22. The method of claim 14, wherein the waste material is NORM.

23. The method of claim 14, wherein the waste material is mercury.

24. A method of liberating a waste material from a substrate, without material changing the structural properties of the substrate, the method comprising:
a. directing a high power laser beam having at least about 5 kW of power at a substrate, the substrate having determinable physical properties defining the structural strength of the substrate;
b. the substrate comprising a base material and a waste material; and,
c. wherein the high power laser beam is directed in a beam delivery pattern to provide an energy absorption per unit length, whereby the energy absorption per unit length is at a level to vaporize the waste material while not materially weakening the structural strength of the substrate.

25. The method of claim 24, wherein the energy absorption per unit length is from about 100 Joules/cm² to about 1,000 Joules/cm².

26. The method of claim 24, wherein the waste material comprises mercury, the base material comprises steel, and the energy absorption per unit length is from about 200 Joules/cm² to about 400 Joules/cm².

27. A system for removing mercury contamination from a structure, the system comprising:
a. a high power laser for providing a laser beam having at least about 5 kW of power;
b. a high power laser umbilical comprising a high power optical fiber having a proximal and a distal end; the proximal end of the optical fiber in optical communication with the high power laser, whereby the laser beam is capable of being transmitted through the optical fiber to the distal end;
c. a vehicle, the vehicle comprising a means for changing the location of the vehicle, a positioning system, an arm having a proximal and a distal end, and a laser head;
d. the laser head having an optics package, a laser delivery port, and a waste material inlet port;
e. the distal end of the optical fiber in optical communication with the optics package, whereby the laser beam is capable of being transmitted from the high power laser to the optics package;
f. the optics package positioned in the laser head, whereby the laser beam is capable of being delivered through the laser port;
g. the waste material inlet port in fluid communication with a waste removal system; and,
h. the laser head attached to the distal end of the arm, the arm mechanically associated with the positioning system.

28. The system of claim 27, wherein the positioning system is at least a two axis positioning system.

29. The system of claim 27, wherein the positioning system is at least a three axis positioning system.

30. The system of claim 27, wherein the positioning system is a six axis positioning system.

31. The system of claim 27, comprising a automatic control system, whereby the system is capable of autonomous operation.

32. The system of claim 27, wherein the waste material removal system comprises a pump and a waste removal umbilical.

33. The system of claim 27, comprising a means to create a reduced pressure zone.

34. The method of claim 24, wherein the waste material comprises mercury, the base material comprises steel, and the energy absorption per unit length is from about 400 Joules/cm² to about 600 Joules/cm².
